(19) United States
(12) Patent Application Publication
(10) Pub. No.: US 2011/0240187 A1
(43) Pub. Date: Oct. 6, 2011

(54) Handle Cover

(76) Inventor: Michael Gaynor, Henderson, NV (US)

(21) Appl. No.: 13/042,353

(22) Filed: Mar. 7, 2011

Related U.S. Application Data
(60) Provisional application No. 61/320,381, filed on Apr. 2, 2010.

(51) Int. Cl. B67D 1/08; B65D 65/22

(52) U.S. Cl. 150/154; 222/470

(57) ABSTRACT

A handle cover to indicate that a container holding a consumable such as beer is empty or “tapped out.” The cover is made of a flexible material such as neoprene to permit the cover to fit over beer tap handles of various shapes. The outer surface of the cover may be colored or printed with indicators to inform patrons of the establishment where the beer tap is being used that the draft beer is empty or tapped out, or another status of the keg associated with the beer tap.

### RELATED UNITED STATES APPLICATION DATA

This application claims priority benefit from U.S. Provisional Application No. 61/320,381, filed on Apr. 2, 2010.

### BACKGROUND

The present invention relates to handle covers for beer taps and other dispenser handles. Such handles, particularly beer tap handles, used to dispense consumables come in a variety of shapes and sizes. In the case of beer taps, the shape of the handles are frequently formed to the design of a well known beer logo, or may otherwise include the logo of a particular brand of beer.

A grouping of dispensers such as beer taps may include one or more beer brands that are typically served on draft in pubs, taverns, bars, restaurants and other establishments. The taps for the different beers are grouped together at a dispenser station at the bar where they are visible to the customers. For many years, it has been common practice that when the keg of a particular brand of beer is empty or “tapped out,” the bartender or other pub worker places an empty cup over the corresponding beer tap handle to indicate to customers that the brand of beer is no longer available. Other indicators have also been used such as removing the tap handle or tying a napkin around the handle. These and other informal indicators signal to the customer that the particular beer brand is tapped out and they will need to make a different choice. However, these techniques diminish the aesthetics of the bar and are generally unattractive.

The present invention is a handle cover that can be quickly and easily slipped over the handle to indicate that the consumable that was being dispensed has been emptied. For example, in the case of a beer keg, the handle cover indicates that the keg is empty or “tapped out.” The cover replaces an unsightly upside down cup or napkin tied around the handle to indicate to customers that the particular beer is no longer available. The cover may be configured in a variety of ways including a fitted shape to fit snugly over a particular handle design. Alternatively, the cover may be configured in a generic shape to fit over any handle and not be inadvertently knocked off. The design of the cover is such that it will not interfere with adjacent handles that continue to supply other types of beer. The cover may be printed in different colors as an indicator to customers that the particular beer is tapped out, or to signal other messages to customers such as that the keg may be running low or is almost empty.

### BRIEF DESCRIPTION OF THE DRAWINGS

For a better understanding of the present invention, and to show more clearly how it functions, reference will now be made, by way of example, to the accompanying drawings. The drawings show embodiments of the present invention in which:

FIG. 1 shows a dispenser station with a grouping of beer tap handles of different shapes and sizes;

FIG. 2 is a front view of a single beer tap handle in a customized shape;

FIG. 3 is a front view of a beer tap handle with an upside down cup placed over it;

FIGS. 4A-G show alternative embodiments of the handle cover of the present invention; and

FIG. 5 shows a handle with a handle cover of the present invention in place.

### SPECIFICATIONS

### Detailed Description of the Invention

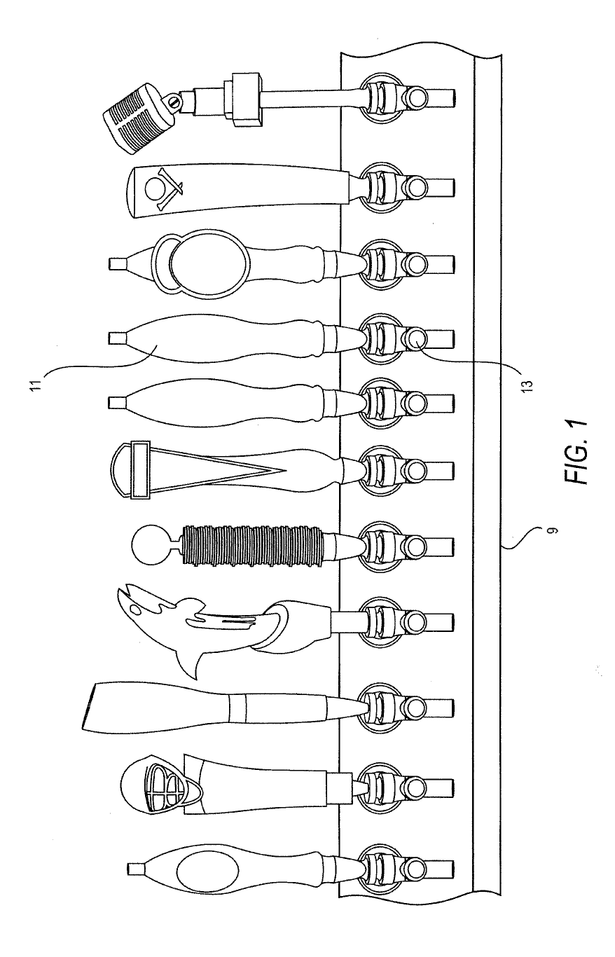

The present invention will now be described more fully with reference to the accompanying drawings. It should be understood that the invention may be embodied in many different forms and should not be construed as limited to the embodiments set forth herein. Throughout FIGS. 1-5, like elements of the invention are referred to by the same reference numerals for consistency purposes.

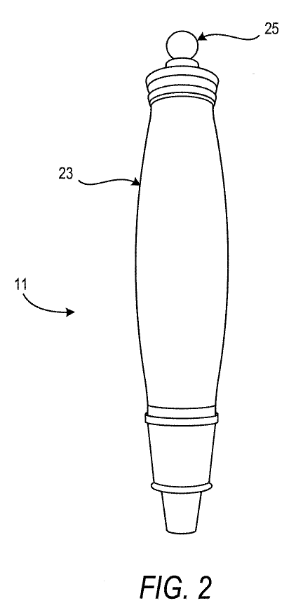

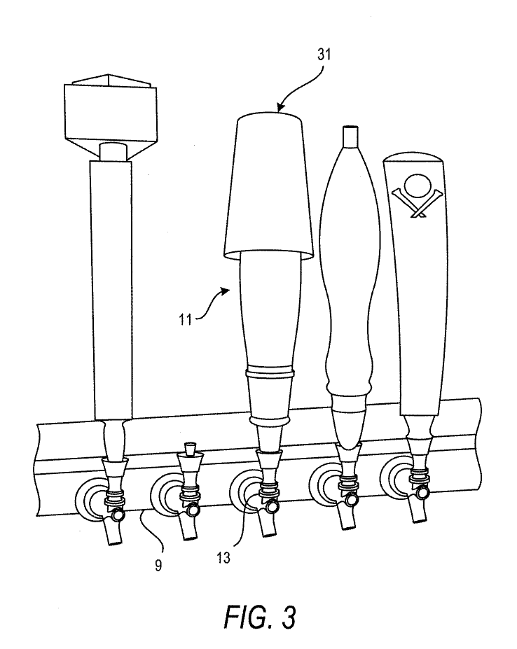

FIG. 1 shows a dispenser station 9 with a group of beer tap handles 11 of different sizes and shapes. Each tap handle 11 is associated with a particular dispenser 13 that is connected to a container or keg that holds a consumable material such as beer. FIG. 2 shows an individual handle 11 of a particular shape where a brand may be printed on or formed into handle 11, and an ornamental element 25, typically situated at the top portion 25. FIG. 3 shows handle 11 with an upside down cup 31 over it to signify that the keg associated with handle 11 is empty or tapped out. Handle 11 is attached to one of many dispensers 13 that are configured in dispenser station 9.

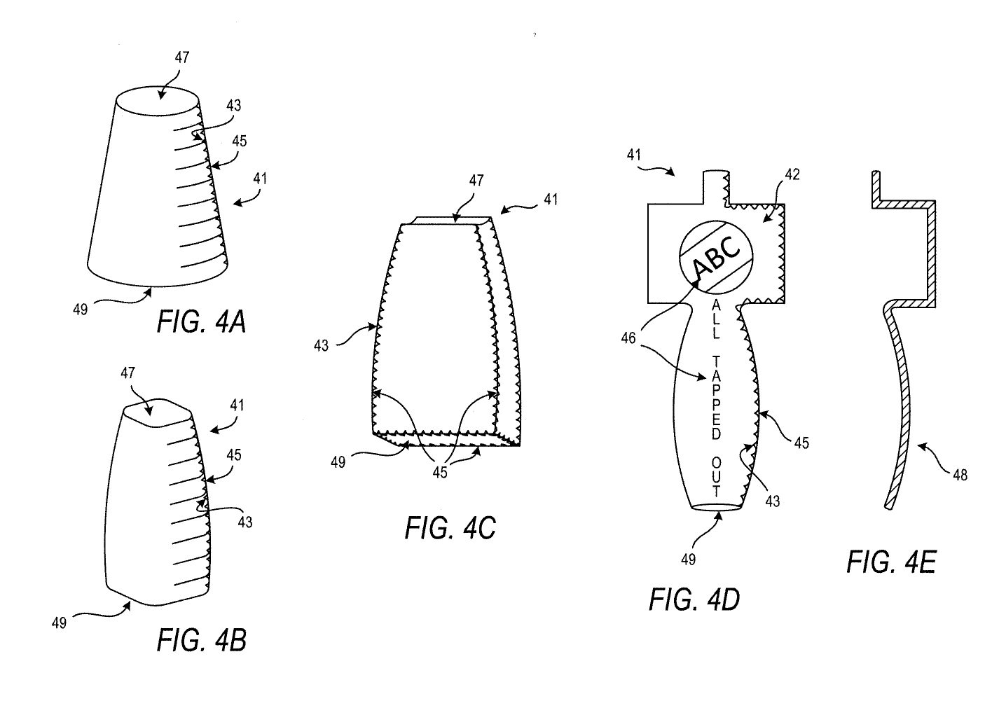

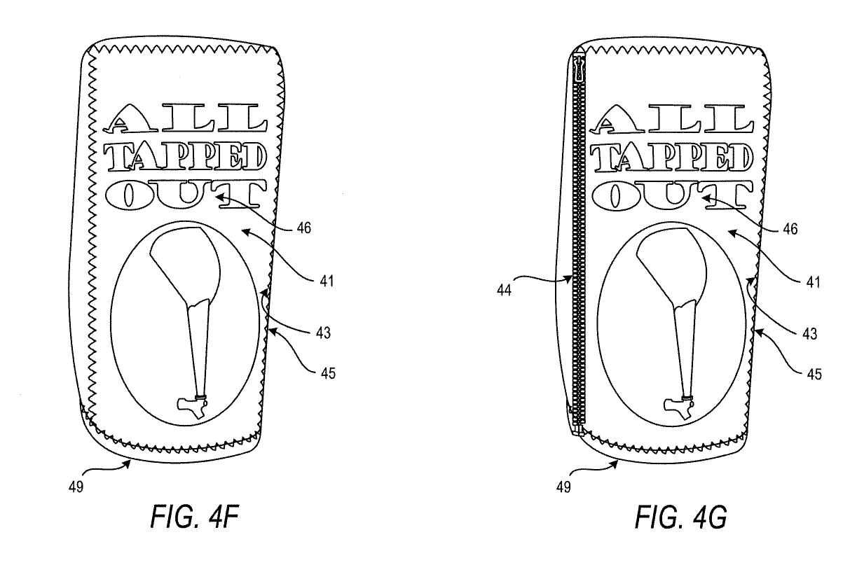

FIGS. 4A-G show alternative embodiments of the present invention. In each of FIGS. 4A-D and 4F-4G, a tap handle cover 41 is formed of flexible material such as neoprene rubber, nylon fabric or closed cell foam that is stitched together using thread 43 along one or more seam(s) 45. The stitching may be accomplished with any type of thread, but nylon or another durable material is preferred to increase the useful life of the handle cover 41. It should also be understood that seam 45 may be alternatively fitted with a zipper 44 to allow handle cover 41 to be opened and closed along seam 45 as shown in FIG. 4F.

Handle cover 41 can be any size or shape. Further, by inserting semi-stiff support member(s) 48 into the flexible material during manufacture or at a later time, handle cover 41 may be made to include square sections, rounded sections or other shape sections to accommodate handles with correspondingly shaped elements formed therein. FIGS. 4A-D and 4F-4G show alternative embodiments of the present invention. It should be understood that the embodiments shown in the figures are representative only.

A top opening 47 at the one end of a cover design may be included to permit a portion of handle 11, such as a top ornamental portion 25, to protrude through cover 41. Top opening 47 may be included in an alternative embodiment of the invention but is not required. An opening 49 at the bottom of handle cover 41 is wide enough to slide handle cover 41 over handle 11 which is connected to dispenser 13. FIG. 4D shows a handle cover 41 with an ornamental square element 42. Square element 42 is formed in handle cover 41 by inserting semi-stiff support members 48 that are intended to align with the edges of a square element on a handle with a square portion. As shown separately in FIG. 4E, semi-stiff support member 48 is inserted into the material forming handle cover 41 to allow handle cover 41 to maintain the appropriate shape. Semi-stiff support member 48 may be made of plastic, metal or any other material that will maintain the shape in cover 41 while easily allowing handle cover 41 to be slid over handle 11. As can be seen in FIGS. 4D and 4F, logos, shapes or other designs, for example, the logo “ABC” inside a circle or the words “All Tapped Out” may be printed on the outside surface of handle cover 41.

FIG. 4G shows a handle cover 41 with a zipper 44 included in the handle cover design. Zipper 44 may be fitted along an entire seam from a first edge at the top to an opposing edge at the bottom so that handle cover 41 can be zipped opened for placement around tap handle 11 and then zipped closed. Alternatively, a zipper design may be cut into only a portion of the seam to enlarge the opening so as to permit the cover to slide over a particularly large section of the handle. Once the cover is slid over handle 11, zipper 44 can be zipped closed.

The exterior surface of handle cover 41 may be any color or combination of colors. For example, a pub may use a red handle cover to indicate that the keg associated with handle 11 is empty. Another handle cover 41 that is yellow may be used to signify that the keg is low and only a few more glasses of beer are available from that keg. A green handle cover 41 may be used when the keg is full or still has a long way to go before it is tapped out. Another use of handle cover 41 is to completely cover tap handle 11 so that customers cannot see the handle underneath. This will eliminate the situation where a customer comes into the pub and sees a tap handle 11 with his or her favorite beer logo on it. That customer, then anticipating and even getting excited about enjoying a glass of his or her favorite beer, becomes disappointed when they learn that the keg associated with the tap handle that s/he sees is connected to an empty keg.

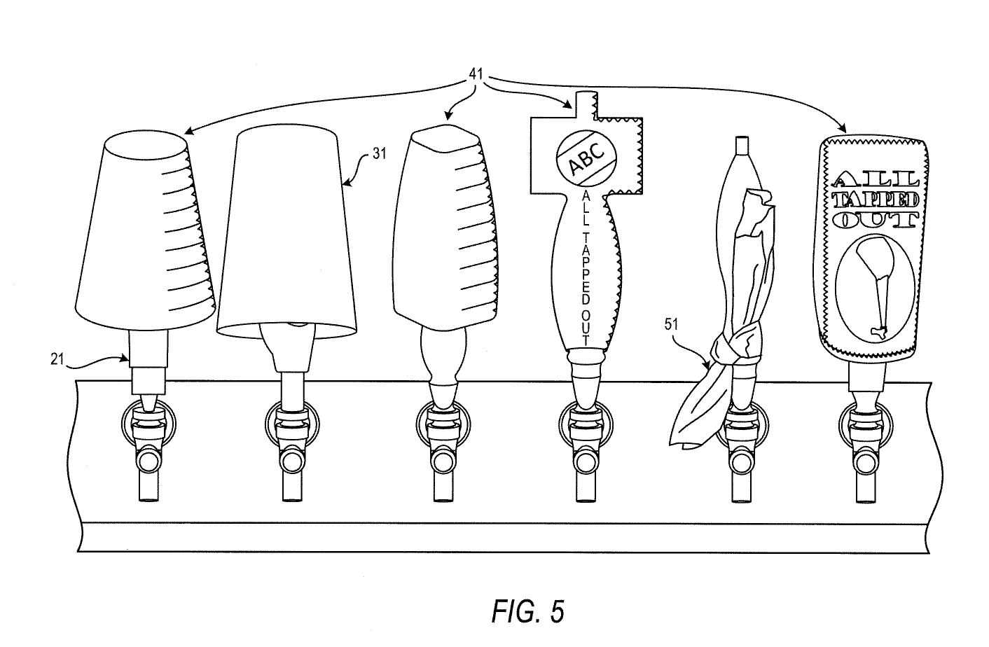

FIG. 5 shows various samples of handle cover 41 in use over tap handles 11. Upside down cup 31 and a napkin 51 are also shown for comparison purposes. As described with respect to FIGS. 4A-F, tap handle cover 41 may be formed in different shapes and sizes to fit over particular tap handles. Further different colors may be used to convey different messages to pub patrons. Finally, it should be understood that the tap handle cover may also be used to reduce the spread of germs. Neoprene and other materials used to form tap handle cover 41 provide a natural antibacterial material fitted over the handles. Since multiple pub workers who touch and operate the tap handles over and over again during a work shift may spread germs among themselves and pub patrons, the use of tap handle cover 41 on each of tap handles 11 encourages a healthier environment. It should also be understood that tap handle 41 may be used for handles that dispense other beverages or consumables other than beer. For example, handle cover 41 may be shaped to fit over the handle of a soft serve ice cream machine.

While the invention has been described with respect to the figures, it will be appreciated that many modifications and changes may be made by those skilled in the art without departing from the spirit of the invention. Any variation and derivation from the above description and drawings are included in the scope of the present invention as defined by the claims

What is claimed is:

1. A handle cover comprising:
a flexible material contoured to surround a handle;
a first opening formed at one end of the flexible material through which the handle passes; and
an indicator on the exterior surface of the flexible material of the handle cover.

2. The handle cover of claim 1 further comprising a member for maintaining a shape of the handle cover.

3. A second opening in the handle cover through which a portion of the handle protrudes.

4. The handle cover of claim 1 wherein the flexible material stretches over the handle to form a snug fit around the handle.

5. The handle cover of claim 1 wherein the flexible material fits loosely over the handle.

6. The handle cover of claim 1 wherein the indicator is a color.

7. The handle cover of claim 1 wherein the indicator is printed material conveying a message.

8. The handle cover of claim 1 wherein the flexible material is a natural disinfectant.

9. The handle cover of claim 1 wherein the handle cover is for covering a beer tap handle that is used to dispense beer from a beer keg.

10. The handle cover of claim 1 wherein the handle cover is for covering an ice cream dispenser handle that is used to dispense ice cream.

11. The handle cover of claim 1 further comprising a zipper for closing a seam in the handle cover after it has been placed over a handle.

12. A system for indicating to patrons the status of one or more containers for holding consumables, the system comprising:
a consumables dispensing station with a plurality of dispensers wherein each dispenser has an associated handle and each handle is activated to dispense a particular beverage through the dispenser from one of the containers; and
at least one handle cover formed of flexible material and shaped with an opening to fit over one or more of the handles to indicate to patrons a status of the beverage in a particular container to which the dispenser and associated handle correspond.

13. The system of claim 12 further comprising at least one semi-rigid member inserted in a handle cover for maintaining a shape of f the handle cover in which it is inserted.

14. The system of claim 12 further comprising a second opening in one of the handle covers through which a portion of a handle protrudes.

15. The handle cover of claim 12 wherein the flexible material stretches over the handle to form a snug fit around the handle.

16. The handle cover of claim 12 wherein the flexible material fits loosely over the handle.

17. The handle cover of claim 12 wherein the indicator is a color.

18. The handle cover of claim 12 wherein the indicator is print material conveying a message.

19. The handle cover of claim 12 wherein the flexible material is a natural disinfectant.

20. The handle cover of claim 12 wherein the handle cover is for covering a beer tap handle that is used to dispense beer from a beer keg.

21. The handle cover of claim 12 wherein the handle cover is for covering an ice cream dispenser handle that is used to dispense ice cream.

22. The handle cover of claim 12 further comprising a zipper for closing a seam in the handle cover after it has been placed over a handle.
